(19) United States
(12) Patent Application Publication
(10) Pub. No.: US 2012/0143757 A1
(43) Pub. Date: Jun. 7, 2012

(54) Designation of Electronic Financial Transactions

(76) Inventor: Serge Christian Pierre Belamant, Sandton (ZA)

(21) Appl. No.: 12/515,093

(22) PCT Filed: Nov. 16, 2007
(86) PCT No.: PCT/IB07/54676

§ 371 Date: Jan. 5, 2010

(30) Foreign Application Priority Data
Nov. 16, 2006 (ZA) 2006/09535

(51) Int. Cl. G06Q 40/00

(52) U.S. Cl. 705/44; 705/39

(57) ABSTRACT

An electronic financial transaction system has an identifier designation determining means for determining a designation of an identifier supplied by a prospective transactor in accordance with his circumstances; and a response means for implementing a predetermined response according to the designation of the identifier. The designation can be either “normal” or “duress”. If a “normal” identifier is given then the transactor is allowed a normal suite of transactions. If a “duress” identifier is given then no transactions are permitted, the transactor's account is frozen, and personnel are alerted to assist the transactor. Alternatively, limited transactions are permitted and the personnel alerted.

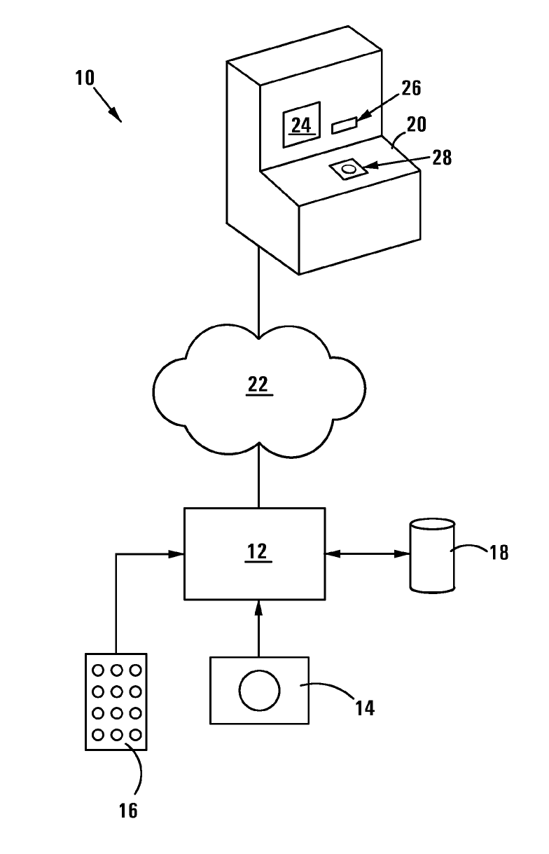

This invention relates to electronic financial transactions. More particularly it relates to an electronic financial transaction system and method.

Generally according to the invention a financial transactor has a plurality of identifiers to cater for the transactors circumstances, each identifier being associated with a different level of permitted service. In particular, one identifier may be a “normal” identifier, which will result in normal financial transactions being supplied and another may be a “duress” identifier for use when the transactor is under duress, which will indicate that the transactor is under duress.

The identifier may be a code and/or biometric, such as a fingerprint.

Thus, according to a first aspect of the invention there is provided an electronic financial transaction system which includes
an identifier designation determining means for determining a designation of an identifier supplied by a prospective transactor in accordance with his circumstances; and
a response means for implementing a predetermined response according to the designation of the identifier.

Further according to the invention there is provided a method of controlling an electronic financial transaction which includes
determining a designation of an identifier supplied by a prospective transactor in accordance with his circumstances; and
implementing a predetermined response according to the designation of the identifier.

In particular, one identifier may indicate that a normal transaction is desired by the transactor and may be designated a “normal” identifier, whereas another identifier may indicate that the transactor is under duress and may be designated a “duress” identifier. Thus, the transactor may be permitted to continue transacting if the identifier supplied is a normal identifier and he may be refused a transaction if the identifier is a duress identifier

It will be appreciated that the invention will be particularly applicable with ATM and Internet, telephonic and similar transactions.

If the normal identifier is supplied by the person, then a normal suite of transactions, such as transfers, balances, cash withdrawals, payments, etc may be made available. If the identifier supplied is a duress identifier, then a predetermined duress response is implemented. The duress response may be to block all transactions, supply an appropriate message, freeze the account, and supply an alarm to appropriate personnel. Instead, the duress response may be to permit certain predefined transactions and supply an alarm to appropriate personnel.

The system may have an input means whereby a person may enter his identifiers and designate which is a normal identifier and which is a duress identifier. The system may then also have a storage means for storing the identifiers and their designations. The storage means may incorporate a database which contains data such as the person's details, the account details, the identifiers and their designations.

It will be appreciated further that there may be more than two identifiers, such that there could be “low duress”, “medium duress” and “high duress” identifiers as well as a “normal”, “transfer only” and “balance only” identifiers.

The system may also have an identifier varying means whereby a customer of a financial institution may vary his identifiers and/or their designations.

The invention will now be described by way of a non-limiting example, with reference to the accompanying diagrammatic drawing, which shows schematically an electronic financial transaction system in accordance with the invention.

In the drawing, reference numeral 10, generally refers to an electronic financial transaction system in accordance with the invention. The system 10 has a processor 12, a fingerprint scanner 14, a keypad 16 and a storage device 18. When a customer of a bank opens an account, three of his fingerprints are scanned by means of the scanner 14, One of these is designated by the customer as being a “normal” identifier, one as a “low duress” identifier and the third as a “high duress” identifier; by means of the keypad 16. The three scans and their associated designations are stored in the storage device 18, together with the account number and the customer's name. The customer may change the fingers to be used and the designation thereof, also using the keyboard 16 and scanner 14.

The processor 12 and the storage device 18 are located at the bank's computer site and are highly secure. The scanner 14 and keypad 16 could be at a branch, communicating with the processor 12 through the bank's normal communication network.

The system 10 also includes an ATM 20. The ATM 20 is connected with the processor 12 via a communication network 22 which may be the bank's private network or the Internet. The ATM 20 has, inter alia, a display screen 24, a card reader 26 and a fingerprint scanner 28.

In use, the customer inserts a card that is associated with the account into the card reader 26 and then provides one of his fingers for scanning by the scanner 28. If the customer is under extreme duress he presents the appropriate finger which was previously designated as the “high duress” identifier. The scan and the account number are transmitted to the processor 12. The processor then determines that the high duress identifier has been provided and responds accordingly. Thus, even if the customer has a large credit balance, a small debit balance is displayed on the screen 24 and the customer is permitted to withdraw a small amount of cash. An alarm is also triggered. If the finger corresponding to the “normal” identifier is provided, then the normal suite of transactions is permitted. If the “low duress” finger is presented, then no transactions whatsoever are permitted, an alarm is raised and the account is frozen.

1. An electronic financial transaction system which includes an identifier designation determining means for determining a designation of an identifier supplied by a prospective transactor in accordance with his circumstances; and a response means for implementing a predetermined response according to the designation of the identifier.

2. The electronic financial transaction system as claimed in claim 1, in which the designation is “normal” or “duress”.

3. The electronic financial transaction system as claimed in claim 2, in which the “duress” designation is “low duress”, “medium duress” or “high duress”.

4. The electronic financial transaction system as claimed in claim 2, in which the response implemented is to permit a normal suite of transactions if the designation of the identifier is “normal”.

5. The electronic financial transaction system as claimed in claim 2, in which the response implemented is not to permit any transaction and to activate a duress procedure if the designation of the identifier is “duress”.

6. The electronic financial transaction system as claimed in claim 5, in which the response implemented includes freezing the transactor's account and the duress procedure includes alerting duress personnel.

7. The electronic financial transaction system as claimed in claim 2, in which the response implemented is to permit predefined limited transactions and to alert duress personnel.

8. The electronic financial transaction system as claimed in claim 1, which includes an input means whereby a customer of a financial institution may enter his identifiers and their designations.

9. The electronic financial transaction system as claimed in claim 8, which includes a storage means for storing the identifiers and their designations for participating customers of the financial institution.

10. The electronic financial transaction system as claimed in claim 9, which includes an identifier varying means whereby a customer of the financial institution may vary his identifiers or their designations.

11. The electronic financial transaction system as claimed in claim 1, in which the identifier is a code or a biometric.

12. A method of controlling an electronic financial transaction which includes determining a designation of an identifier supplied by a prospective transactor in accordance with his circumstances; and implementing a predetermined response according to the designation of the identifier.

13. The method of controlling an electronic financial transaction as claimed in claim 12, in which the designation is “normal” or “duress”.

14. The method of controlling an electronic financial transaction as claimed in claim 13, in which the “duress” designation is “low duress”, “medium duress” or “high duress”.

15. The method of controlling an electronic financial transaction as claimed in claim 13, in which the response is to permit a normal suite of transactions if the designation of the identifier is “normal”.

16. The method of controlling an electronic financial transaction as claimed in claim 13, in which the response is not to permit any transaction and to activate a duress procedure if the designation of the identifier is “duress”.

17. The method of controlling an electronic financial transaction as claimed in claim 16, in which the duress procedure includes freezing the transactor's account and alerting duress personnel.

18. The method of controlling an electronic financial transaction as claimed in claim 13, in which the response is to permit predefined limited transactions and to activate a duress procedure if the designation of the identifier is “duress”.

19. The method of controlling an electronic financial transaction as claimed in claim 12, which includes allowing a customer of a financial institution to enter his identifiers and their designations.

20. The method of controlling an electronic financial transaction as claimed in claim 19, which includes storing customer's identifiers and their designations.

21. The method of controlling an electronic financial transaction as claimed in claim 20, which includes allowing customer's to vary their identifiers and their designations.

22. The method of controlling an electronic financial transaction as claimed in claim 12, in which the identifier is a code or a biometric.

23-24. (canceled)
